(19) United States
(12) Patent Application Publication
(10) Pub. No.: US 2019/0005709 A1
(43) Pub. Date: Jan. 3, 2019

(54) Techniques for Correction of Visual Artifacts in Multi-View Images

(71) Applicant: Apple Inc., Cupertino, CA (US)

(72) Inventors: Jae Hoon Kim, San Jose, CA (US); Dazhong Zhang, Milpitas, CA (US); Hang Yuan, San Jose, CA (US); Hsi-Jung Wu, San Jose, CA (US); Jiefu Zhai, San Jose, CA (US); Ming Chen, Cupertino, CA (US); Xiaosong Zhou, Campbell, CA (US)

(21) Appl. No.: 15/638,587

(22) Filed: Jun. 30, 2017

(51) Int. Cl. G06T 15/20; H04N 13/02; H04N 5/232; H04N 19/117

(52) U.S. Cl. CPC G06T 15/20; H04N 19/117; H04N 5/23238; H04N 13/0285

(57) ABSTRACT

Techniques are disclosed for correcting artifacts in multi-view images that include a plurality of planar views. Image content the planar views may be projected from the planar representation to a spherical projection. Thereafter, a portion of the image content may be projected from the spherical projection to a planar representation. The image content of the planar representation may be used for display. Extensions are disclosed that correct artifacts that may arise during deblocking filtering of the multi-view images.

### BACKGROUND

The present disclosure relates to techniques for correcting image artifacts in multi-view images.

Some modern imaging applications capture image data from multiple directions about a camera. Many cameras have multiple imaging systems that capture image data in several different fields of view. An aggregate image may be created that represents a merger or “stitching” of image data captured from these multiple views.

Oftentimes, the images created from these capture operations exhibit visual artifacts due to discontinuities in the fields of view. For example, a “cube map” image, described herein, may be generated from the merger of six different planar images that define a cubic space about a camera. Each planar view represents image content of objects within the view's respective field of view. Thus, each planar view possesses its own perspective and its own vanishing point, which is different than the perspectives and vanishing points of the other views of the cube map image. Visual artifacts can arise at seams between these images. The artifacts are most pronounced when parts of a common object are represented in multiple views. Parts of the object may appear as if they are at a common depth in one view but other parts of the object may appear as if they have variable depth in the second view.

The inventors perceive a need in the art for image correction techniques that mitigate such artifacts in multi-view images.

### BRIEF DESCRIPTION OF THE DRAWINGS

FIG. 1 illustrates a system in which embodiments of the present disclosure may be employed.

FIG. 2 is a functional block diagram of a coding system according to an embodiment of the present disclosure.

FIG. 3 is a functional block diagram of a decoding system according to an embodiment of the present disclosure.

FIG. 4 illustrates an image source that generates multi-directional image data according to an embodiment of the present disclosure.

FIG. 5 illustrates another image source that generates multi-directional image data according to an embodiment of the present disclosure.

FIG. 6 illustrates a further image source that generates multi-directional image data according to an embodiment of the present disclosure.

FIG. 7 illustrates an example of a discontinuity that may be mitigated according to an embodiment of the present disclosure.

FIG. 8 illustrates an exemplary scenario that might give rise to the image data illustrated in FIG. 7.

FIG. 9 illustrates an exemplary transform of image data to mitigate visual artifacts in multi-view image data, according to an embodiment of the present disclosure.

FIG. 10 illustrates another exemplary transform of image data to mitigate visual artifacts in multi-view image data, according to an embodiment of the present disclosure.

FIG. 11 illustrates an exemplary image format for a multi-view image capture according to a tetrahedral view space, according to an embodiment of the present disclosure.

FIG. 12 illustrates an exemplary image format for a multi-view image capture according to an octahedral view space, according to an embodiment of the present disclosure.

FIG. 13 illustrates an exemplary image format for a multi-view image capture according to a dodecahedral view space, according to an embodiment of the present disclosure.

FIG. 14 illustrates an exemplary image format for a multi-view image capture according to an icosahedral view space, according to an embodiment of the present disclosure.

FIG. 15(A) illustrates an exemplary multi-view capture operation according to an embodiment of the present disclosure.

FIG. 15(B) illustrates an exemplary image format for a multi-view image capture operation as illustrated in FIG. 15(A).

FIG. 16 is a functional block diagram of a coding system according to an embodiment of the present disclosure.

FIG. 17 is a functional block diagram of a decoding system according to an embodiment of the present disclosure.

FIG. 18(A) illustrates an exemplary image format on which a padding technique according to an embodiment of the present disclosure may be performed.

FIG. 18(B) illustrates a padding technique according to an embodiment of the present disclosure as applied to a sub-image from FIG. 18(A).

FIG. 18(C) illustrates an exemplary padded image format according to an embodiment of the present disclosure.

FIG. 19(A) illustrates a padding technique according to an embodiment of the present disclosure as applied to a sub-image of a multi-view image.

FIG. 19(B) illustrates a padding technique according to an embodiment of the present disclosure as applied to another sub-image of a multi-view image.

FIG. 19(C) illustrates an exemplary padded image format according to an embodiment of the present disclosure.

FIG. 20(A) illustrates an exemplary image format on which a padding technique according to an embodiment of the present disclosure may be performed.

FIG. 20(B) illustrates a padding technique according to an embodiment of the present disclosure as applied to a sub-image from FIG. 20(A).

FIG. 20(C) illustrates a padding technique according to an embodiment of the present disclosure as applied to a sub-image from FIG. 20(A).

FIG. 21 illustrates an exemplary computer system in which embodiments of the present disclosure may be employed.

### DETAILED DESCRIPTION

Embodiments of the present invention provide an image correction technique for multi-view image that includes a plurality of planar views. Image content the planar views may be projected from the planar representation to a spherical projection. Thereafter, a portion of the image content may be projected from the spherical projection to a planar representation. The image content of the planar representation may be used for display. Extensions of the disclosure provide techniques to correct artifacts that may arise during deblocking filtering of the multi-view images.

FIG. 1 illustrates a system 100 in which embodiments of the present disclosure may be employed. The system 100 may include at least two terminals 110-120 interconnected via a network 130. The first terminal 110 may have an image source that generates multi-view image. The terminal 110 also may include coding systems and transmission systems (not shown) to transmit coded representations of the multi-view image to the second terminal 120, where it may be consumed. For example, the second terminal 120 may display the multi-view image on a local display, it may execute a video editing program to modify the multi-view image, or may integrate the multi-view image into an application (for example, a virtual reality program), it may display a representation of the image in a head mounted display (for example, virtual reality applications) or it may store the multi-view image for later use.

FIG. 1 illustrates components that are appropriate for unidirectional transmission of multi-view image, from the first terminal 110 to the second terminal 120. In some applications, it may be appropriate to provide for bidirectional exchange of video data, in which case the second terminal 120 may include its own image source, video coder and transmitters (not shown), and the first terminal 110 may include its own receiver and display (also not shown). If it is desired to exchange multi-view video bidirectionally, then the techniques discussed hereinbelow may be replicated to generate a pair of independent unidirectional exchanges of multi-view video. In other applications, it would be permissible to transmit multi-view video in one direction (e.g., from the first terminal 110 to the second terminal 120) and transmit “flat” video (e.g., video from a limited field of view) in a reverse direction.

In FIG. 1, the second terminal 120 is illustrated as a computer display but the principles of the present disclosure are not so limited. Embodiments of the present disclosure find application with laptop computers, tablet computers, smart phones, servers, media players, virtual reality head mounted displays, augmented reality display, hologram displays, and/or dedicated video conferencing equipment. The network 130 represents any number of networks that convey coded video data among the terminals 110-120, including, for example, wireline and/or wireless communication networks. The communication network 130 may exchange data in circuit-switched and/or packet-switched channels. Representative networks include telecommunications networks, local area networks, wide area networks and/or the Internet. For the purposes of the present discussion, the architecture and topology of the network 130 is immaterial to the operation of the present disclosure unless explained hereinbelow.

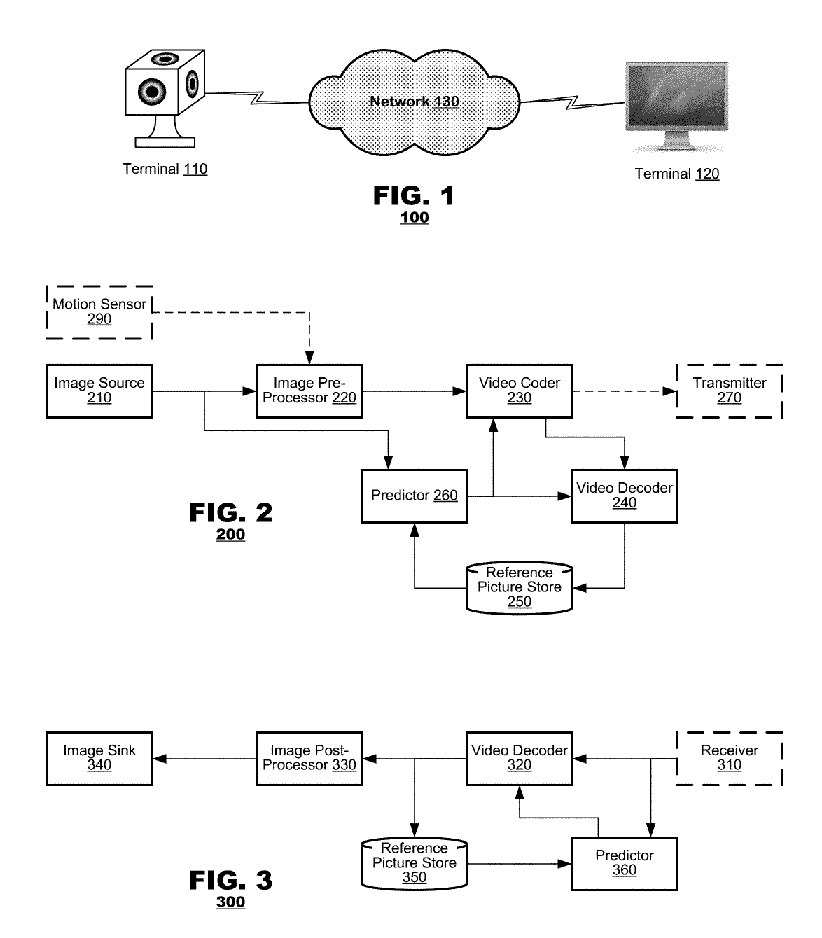

FIG. 2 is a functional block diagram of a coding system 200 according to an embodiment of the present disclosure. The system 200 may include an image source 210, an image pre-processing system 220, a video coder 230, a video decoder 240, a reference picture store 250, and a predictor 260.

The image source 210 may generate image data as a multi-directional image, containing image data of a field of view that extends around a reference point in multiple directions.

The image pre-processing system 220 may process the input images to condition them for coding by the video coder 230. For example, the image pre-processor 220 may perform image formatting, projection and/or padding operations as described herein.

The video coder 230 may generate a coded representation of its input image data, typically by exploiting spatial and, for video, or temporal redundancies in the image data. The video coder 230 may output a coded representation of the input data that consumes less bandwidth than the original source video when transmitted and/or stored.

For video, the video decoder 240 may invert coding operations performed by the video encoder 230 to obtain a reconstructed picture from the coded video data. Typically, the coding processes applied by the video coder 230 are lossy processes, which cause the reconstructed picture to possess various errors when compared to the original picture. The video decoder 240 may reconstruct select coded pictures, which are designated as “reference pictures,” and store the decoded reference pictures in the reference picture store 250. In the absence of transmission errors, the decoded reference pictures will replicate decoded reference pictures obtained by a decoder (not shown in FIG. 2).

The predictor 260 may select prediction references for new input pictures as they are coded. For each portion of the input picture being coded (called a “pixel block” for convenience), the predictor 260 may select a coding mode and identify a portion of a reference picture that may serve as a prediction reference search for the pixel block being coded. The coding mode may be an intra-coding mode, in which case the prediction reference may be drawn from a previously-coded (and decoded) portion of the picture being coded. Alternatively, the coding mode may be an inter-coding mode, in which case the prediction reference may be drawn from another previously-coded and decoded picture.

When an appropriate prediction reference is identified, the predictor 260 may furnish the prediction data to the video coder 230. The video coder 230 may code input video data differentially with respect to prediction data furnished by the predictor 260. Typically, prediction operations and the differential coding operate on a pixel block-by-pixel block basis. Prediction residuals, which represent pixel-wise differences between the input pixel blocks and the prediction pixel blocks, may be subject to other coding operations to reduce bandwidth further.

As indicated, the coded video data output by the video coder 230 should consume less bandwidth than the input data when transmitted and/or stored. The coding system 200 may output the coded video data to an output device 270, such as a transmitter, that may transmit the coded video data across a communication network 130 (FIG. 1). Alternatively, the coding system 200 may output coded data to a storage device (not shown) such as an electronic-, magnetic- and/or optical storage medium.

FIG. 3 is a functional block diagram of a decoding system 300 according to an embodiment of the present disclosure. The decoding system 300 may include a receiver 310, a video decoder 320, an image post-processor 330, a video sink 340, a reference picture store 350 and a predictor 360. The receiver 310 may receive coded video data from a channel and route it to the video decoder 320. The video decoder 320 may decode the coded video data with reference to prediction data supplied by the predictor 360.

The image post-processor 330 may perform operations on reconstructed video data output from the video decode 320 to condition it for consumption by the video sink 340. As part of its operation, the image post-processor may remove padding information from decoded data. The image post-processor 330 also may perform projection and reformatting operations to alter format of the decoded data to a format of the video sink 340.

The video sink 340, as indicated, may consume decoded video generated by the decoding system 300. Video sinks 340 may be embodied by, for example, display devices that render decoded video. In other applications, video sinks 340 may be embodied by computer applications, for example, gaming applications, virtual reality applications and/or video editing applications, that integrate the decoded video into their content. In some applications, a video sink may process the entire multi-view field of view of the decoded video for its application but, in other applications, a video sink 340 may process a selected sub-set of content from the decoded video. For example, when rendering decoded video on a flat panel display, it may be sufficient to display only a selected sub-set of the multi-view video. In another application, decoded video may be rendered in a multi-view format, for example, in a planetarium.

Image sources 210 that capture multi-directional images often generate image data that include discontinuities in image content. Such discontinuities often occur at “seams” between fields of view of the camera sub-systems that capture image data in various fields of, from which a final multidirectional image is created.

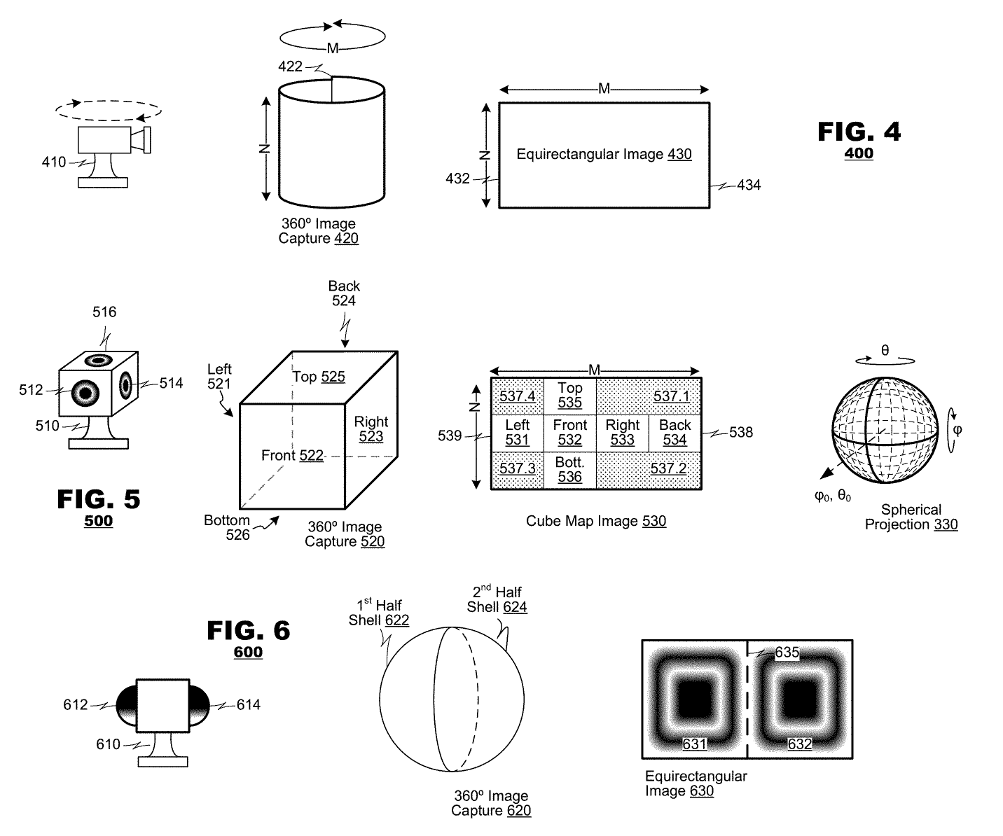

FIG. 4 illustrates an image source 410 that generates multi-directional image data. The image source 410 may be a camera that has a single image sensor (not shown) that pivots along an axis. During operation, the camera 410 may capture image content as it pivots along a predetermined angular distance 420 (preferably, a full 360°) and may merge the captured image content into a 360° image. The capture operation may yield an equirectangular image 430 that represents a multi-directional field of view having been partitioned along a slice 422 that divides a cylindrical field of view into a two dimensional array of data. In the equirectangular image 430, pixels on either edge 432, 434 of the image 430 represent adjacent image content even though they appear on different edges of the equirectangular image 430. Thus, pixels along the edges 432, 434 may give rise to discontinuities in content of the equirectangular image 430.

FIG. 5 illustrates image capture operations of another type of image source, an omnidirectional camera 510. In this embodiment, a camera system 510 may possess image sensors 512-516 that capture image data in different fields of view from a common reference point. The camera 510 may output an equirectangular image 530 in which image content is arranged according to a cube map capture operation 520 in which the sensors 512-516 capture image data in different fields of view 521-526 (typically, six) about the camera 510. The image data of the different fields of view 521-526 may be stitched together according to a cube map layout 530. In the example illustrated in FIG. 5, six sub-images corresponding to a left view 521, a front view 522, a right view 523, a back view 524, a top view 525 and a bottom view 526 may be captured, stitched and arranged within the multi-directional picture 530 according to “seams” of image content between the respective views 521-526. Thus, as illustrated in FIG. 5, pixels from the front image 532 that are adjacent to the pixels from each of the left, the right, the top, and the bottom images 531, 533, 535, 536 represent image content that is adjacent respectively to content of the adjoining sub-images. Similarly, pixels from the right and back images 533, 534 that are adjacent to each other represent adjacent image content. Further, content from a terminal edge 538 of the back image 534 is adjacent to content from an opposing terminal edge 539 of the left image. Image content along the seams between different sub-images 531-536 may give rise to discontinuities in content of the equirectangular image 530. The image 530 also may have regions 537.1-537.4 that do not belong to any image.

FIG. 6 illustrates image capture operations of another omnidirectional camera 600. In the embodiment illustrated in FIG. 6, the imaging system 610 is shown as a panoramic camera composed of a pair of fish eye lenses 612, 614 and associated imaging devices (not shown), each arranged to capture image data in a hemispherical view of view. Images captured from the hemispherical fields of view may be stitched together to represent image data in a full 360° field of view. For example, FIG. 6 illustrates a multi-view image 630 that contains image content 631, 632 from the hemispherical views 622, 624 of the camera and which are joined at a seam 635. Discontinuities may arise along the seam 635 as a result of stitching.

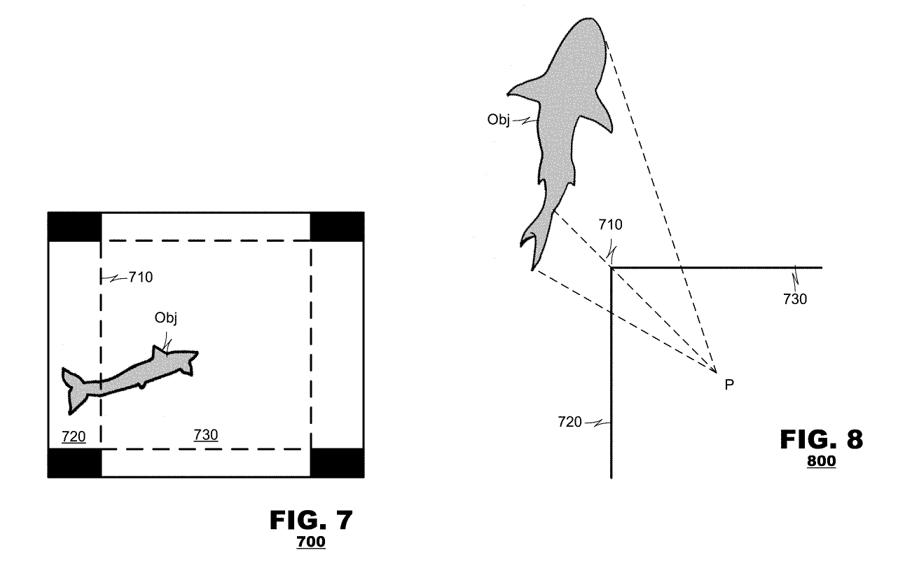

FIG. 7 illustrates an example of a discontinuity that may arise along a seam 710 between views 720, 730 of an equirectangular image 700. In this example, image content of a common object Obj is captured by the two views 720, 730. Although the object appears at a common depth in the first view 720, it appears to have an increasing depth in view 730 at interior positions within the view away from the seam 710.

FIG. 8 figuratively illustrates an imaging scenario that might give rise to the image data illustrated in FIG. 7. As illustrated in FIG. 8, an imaging operation may be performed by a camera at a reference point P. At the time of imaging, an object Obj may be oriented with respect to the reference point P in such a way that part of the object Obj is captured in an imaging plane that corresponds to a first view 720 and another part of the object Obj is captured in an imaging play that corresponds to a second view 730. Due to the object's orientations with respect to the imaging planes of the two views 720, 730 the object Obj appears to be co-planar with the plane of view 720 but receding with respect to the plane of view 730.

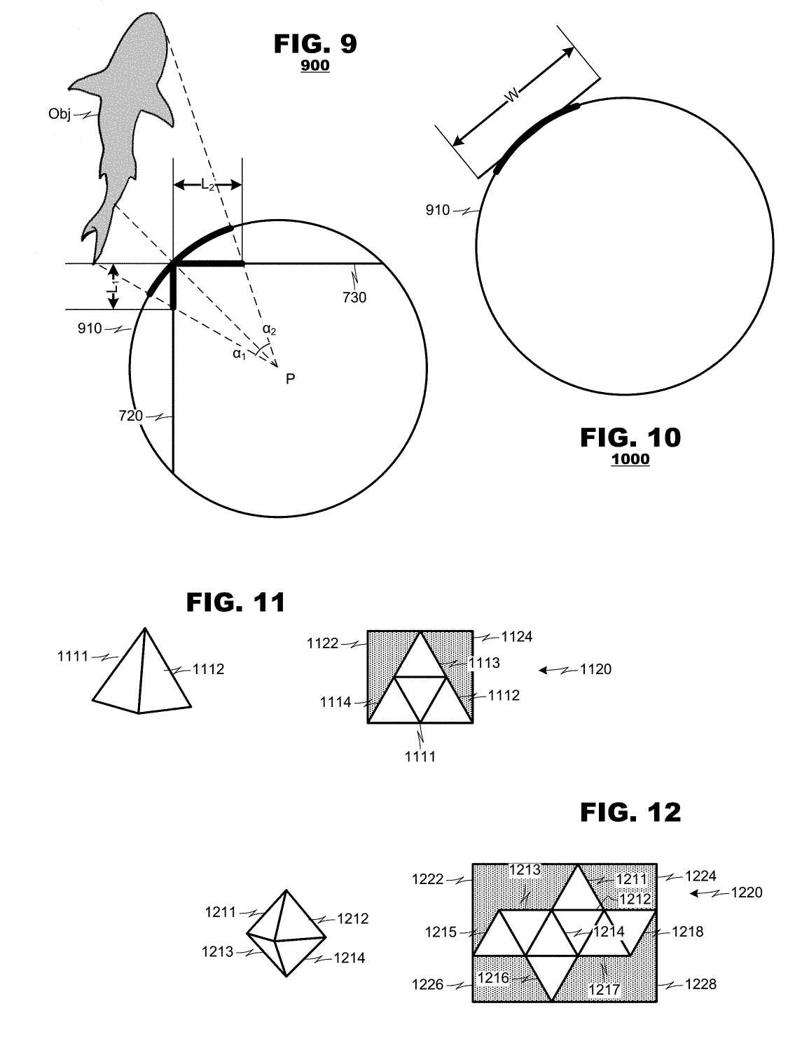

Embodiments of the present disclosure provide techniques for reducing effects of image content discontinuities. FIG. 9 illustrates operations of a first embodiment, in which an image rendering device may transform image content by projecting content from the different views of an image from a native domain of the image to a spherical projection. FIG. 9 illustrates application to the use case of FIGS. 7 and 8. In this embodiment, image content from the planar views 720, 730 may be transformed to a spherical projection 910. In this embodiment, the image rendering device may transform lengths of the object L1, L2 in the planar views 720, 730 to angular projections α1, α2 in the spherical projection 910; although FIG. 9 illustrates a two-dimensional of the concept, the operation may be performed on a 3D projection 910. Thereafter, all or a portion of the image content from the spherical projection 910 may be selected for rendering.

In an embodiment, image rendering may be performed by projecting content from the spherical domain 1010 to a planar domain. For example, as shown in FIG. 10, image rendering often involves selecting a portion W of content from the multi-view image (called a “view window,” for convenience) that will be rendered in a planar display. Image data from the spherical projection 910 may be projected on a planar domain of the view window W. The orientation of the view window W may but need not align with the orientation of one of the planar views 720, 730. In an embodiment, the operations illustrated in FIG. 10 may be performed by a post processor 330 of a decoding system 300 (FIG. 3).

The principles of the present discussion find application with multi-view images captured according to other techniques. For example, as illustrated in FIG. 11, image capture may be performed in which different planar views 1111-1114 have a tetrahedral orientation, which are arranged into an image 1120 to maintain continuity across seams between adjacent views 1111-1114. The image 1120 may have null regions 1122, 1124 that do not contain image content of any of the views.

In another embodiment, illustrated in FIG. 12, image capture may be performed in which different planar views 1211-1218 have an octahedral orientation, which are arranged into an image 1220 to maintain continuity across seams between adjacent views 1211-1218. The image 1220 may have null regions 1122, 1124 that do not contain image content of any of the views.

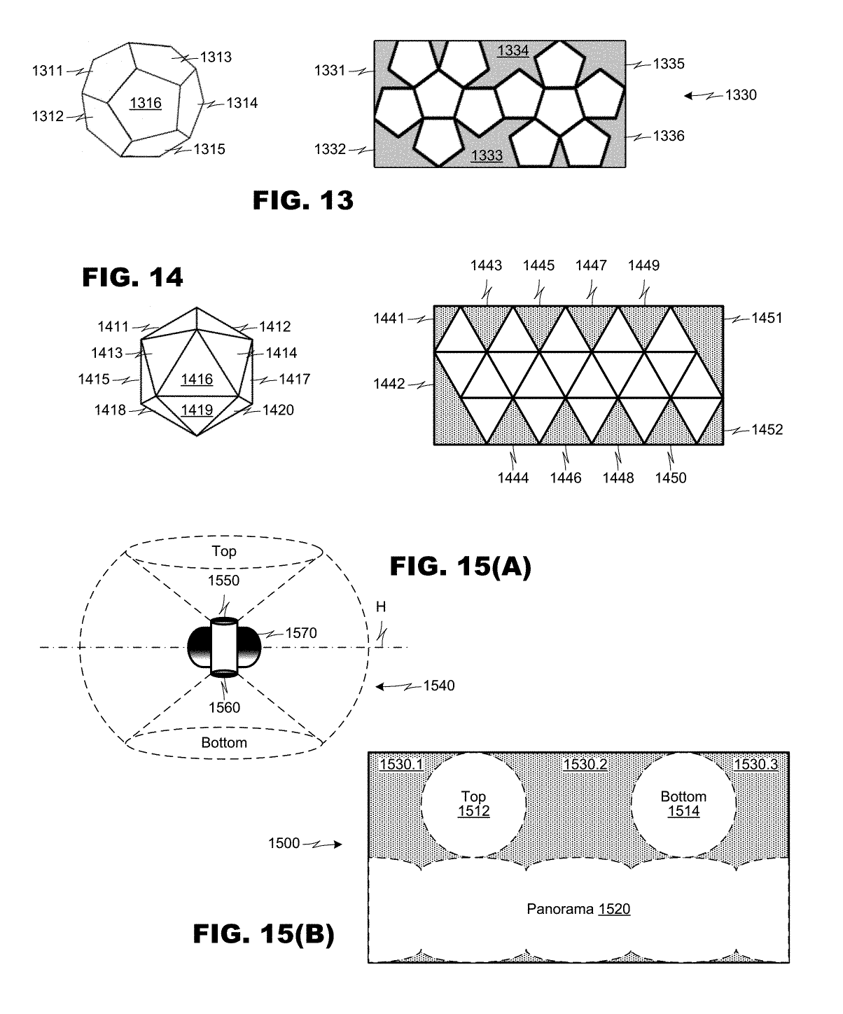

In another embodiment, illustrated in FIG. 13, image capture may be performed in which different planar views 1311-1322 have a dodecahedral orientation, which are arranged into an image 1330 to maintain continuity across seams between adjacent views 1311-1322. The image 1330 may have null regions 1331-1336 that do not contain image content of any of the views 1311-1322.

In a further embodiment, illustrated in FIG. 14, image capture may be performed in which different planar views 1411-1430 have an icosahedral orientation, which are arranged into an image 1440 to maintain continuity across seams between adjacent views 1411-1430. The image 1440 may have null regions 1441-1452 that do not contain image content of any of the views 1411-1430.

The image format may be obtained from an omnidirectional camera 1540 that contains a plurality of imaging systems 1550, 1560, 1570 to capture image data in an omnidirectional field of view. Imaging systems 1550 and 1560 may capture image data in top and bottoms fields of view, respectively, as “flat” images. The imaging system 1570 may capture image data in a 360° field of view about a horizon H established between the top and bottom fields of view. In the embodiment illustrated in FIG. 15, the imaging system 1570 is shown as a panoramic camera composed of a pair of fish eye lenses and associated imaging devices (not shown), each arranged to capture image data in a hemispherical view of view. Images captured from the hemispherical fields of view may be stitched together to represent image data in a full 360° field of view. Such stitching operations, however, may give rise to artifacts that the proposed techniques are designed to mitigate.

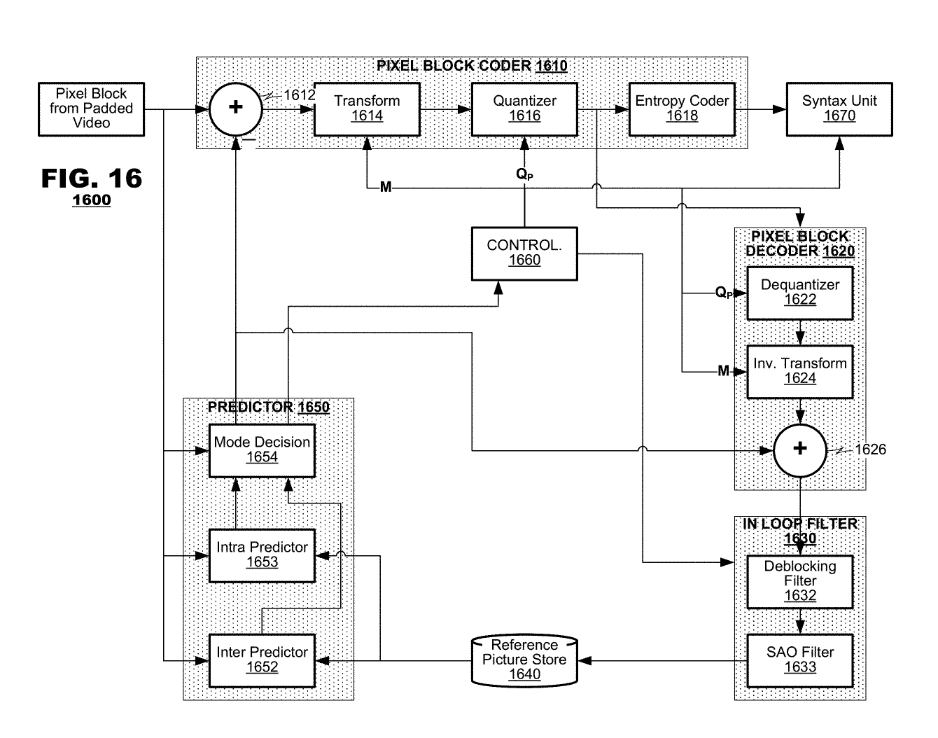

FIG. 16 is a functional block diagram of a coding system 1600 according to an embodiment of the present disclosure. The system 1600 may include a pixel block coder 1610, a pixel block decoder 1620, an in-loop filter system 1630, a reference picture store 1640, a predictor 1650, a controller 1660, and a syntax unit 1670. The pixel block coder and decoder 1610, 1620 and the predictor 1650 may operate iteratively on individual pixel blocks of a picture. The predictor 1650 may predict data for use during coding of a newly-presented input pixel block. The pixel block coder 1610 may code the new pixel block by predictive coding techniques and present coded pixel block data to the syntax unit 1670. The pixel block decoder 1620 may decode the coded pixel block data, generating decoded pixel block data therefrom. The in-loop filter 1630 may perform various filtering operations on a decoded picture that is assembled from the decoded pixel blocks obtained by the pixel block decoder 1620. The filtered picture may be stored in the reference picture store 1640 where it may be used as a source of prediction of a later-received pixel block. The syntax unit 1670 may assemble a data stream from the coded pixel block data which conforms to a governing coding protocol.

The pixel block coder 1610 may include a subtractor 1612, a transform unit 1614, a quantizer 1616, and an entropy coder 1618. The pixel block coder 1610 may accept pixel blocks of input data at the subtractor 1612. The subtractor 1612 may receive predicted pixel blocks from the predictor 1650 and generate an array of pixel residuals therefrom representing a difference between the input pixel block and the predicted pixel block. The transform unit 1614 may apply a transform to the sample data output from the subtractor 1612, to convert data from the pixel domain to a domain of transform coefficients. The quantizer 1616 may perform quantization of transform coefficients output by the transform unit 1614. The quantizer 1616 may be a uniform or a non-uniform quantizer. The entropy coder 1618 may reduce bandwidth of the output of the coefficient quantizer by coding the output, for example, by variable length code words.

The transform unit 1614 may operate in a variety of transform modes as determined by the controller 1660. For example, the transform unit 1614 may apply a discrete cosine transform (DCT), a discrete sine transform (DST), a Walsh-Hadamard transform, a Haar transform, a Daubechies wavelet transform, or the like. In an embodiment, the controller 1660 may select a coding mode M to be applied by the transform unit 1615, may configure the transform unit 1615 accordingly and may signal the coding mode M in the coded video data, either expressly or impliedly.

The quantizer 1616 may operate according to a quantization parameter Q_{P} that is supplied by the controller 1660. In an embodiment, the quantization parameter Q_{P} may be applied to the transform coefficients as a multi-value quantization parameter, which may vary, for example, across different coefficient locations within a transform-domain pixel block. Thus, the quantization parameter Q_{P} may be provided as a quantization parameters array.

The entropy coder 1618, as its name implies, may perform entropy coding of data output from the quantizer 1616. For example, the entropy coder 1618 may perform run length coding, Huffman coding, Golomb coding and the like.

The pixel block decoder 1620 may invert coding operations of the pixel block coder 1610. For example, the pixel block decoder 1620 may include a dequantizer 1622, an inverse transform unit 1624, and an adder 1626. The pixel block decoder 1620 may take its input data from an output of the quantizer 1616. Although permissible, the pixel block decoder 1620 need not perform entropy decoding of entropy-coded data since entropy coding is a lossless event. The dequantizer 1622 may invert operations of the quantizer 1616 of the pixel block coder 1610. The dequantizer 1622 may perform uniform or non-uniform de-quantization as specified by the decoded signal Q_{P}. Similarly, the inverse transform unit 1624 may invert operations of the transform unit 1614. The dequantizer 1622 and the inverse transform unit 1624 may use the same quantization parameters Q_{P} and transform mode M as their counterparts in the pixel block coder 1610. Quantization operations likely will truncate data in various respects and, therefore, data recovered by the dequantizer 1622 likely will possess coding errors when compared to the data presented to the quantizer 1616 in the pixel block coder 1610.

The adder 1626 may invert operations performed by the subtractor 1612. It may receive the same prediction pixel block from the predictor 1650 that the subtractor 1612 used in generating residual signals. The adder 1626 may add the prediction pixel block to reconstructed residual values output by the inverse transform unit 1624 and may output reconstructed pixel block data.

The in-loop filter 1630 may perform various filtering operations on recovered pixel block data. For example, the in-loop filter 1630 may include a deblocking filter 1632 and a sample adaptive offset (“SAO”) filter 1633. The deblocking filter 1632 may filter data at seams between reconstructed pixel blocks to reduce discontinuities between the pixel blocks that arise due to coding. SAO filters may add offsets to pixel values according to an SAO “type,” for example, based on edge direction/shape and/or pixel/color component level. The in-loop filter 1630 may operate according to parameters that are selected by the controller 1660.

The reference picture store 1640 may store filtered pixel data for use in later prediction of other pixel blocks. Different types of prediction data are made available to the predictor 1650 for different prediction modes. For example, for an input pixel block, intra prediction takes a prediction reference from decoded data of the same picture in which the input pixel block is located. Thus, the reference picture store 1640 may store decoded pixel block data of each picture as it is coded. For the same input pixel block, inter prediction may take a prediction reference from previously coded and decoded picture(s) that are designated as reference pictures. Thus, the reference picture store 1640 may store these decoded reference pictures.

As discussed, the predictor 1650 may supply prediction data to the pixel block coder 1610 for use in generating residuals. The predictor 1650 may include an inter predictor 1652, an intra predictor 1653 and a mode decision unit 1652. The inter predictor 1652 may receive pixel block data representing a new pixel block to be coded and may search reference picture data from store 1640 for pixel block data from reference picture(s) for use in coding the input pixel block. The inter predictor 1652 may support a plurality of prediction modes, such as P mode coding and B mode coding. The inter predictor 1652 may select an inter prediction mode and an identification of candidate prediction reference data that provides a closest match to the input pixel block being coded. The inter predictor 1652 may generate prediction reference metadata, such as motion vectors, to identify which portion(s) of which reference pictures were selected as source(s) of prediction for the input pixel block.

The intra predictor 1653 may support Intra (I) mode coding. The intra predictor 1653 may search from among pixel block data from the same picture as the pixel block being coded that provides a closest match to the input pixel block. The intra predictor 1653 also may generate prediction reference indicators to identify which portion of the picture was selected as a source of prediction for the input pixel block.

The mode decision unit 1652 may select a final coding mode to be applied to the input pixel block. Typically, as described above, the mode decision unit 1652 selects the prediction mode that will achieve the lowest distortion when video is decoded given a target bitrate. Exceptions may arise when coding modes are selected to satisfy other policies to which the coding system 1600 adheres, such as satisfying a particular channel behavior, or supporting random access or data refresh policies. When the mode decision selects the final coding mode, the mode decision unit 1652 may output a selected reference block from the store 1640 to the pixel block coder and decoder 1610, 1620 and may supply to the controller 1660 an identification of the selected prediction mode along with the prediction reference indicators corresponding to the selected mode.

The controller 1660 may control overall operation of the coding system 1600. The controller 1660 may select operational parameters for the pixel block coder 1610 and the predictor 1650 based on analyses of input pixel blocks and also external constraints, such as coding bitrate targets and other operational parameters. As is relevant to the present discussion, when it selects quantization parameters Q_{P}, the use of uniform or non-uniform quantizers, and/or the transform mode M, it may provide those parameters to the syntax unit 1670, which may include data representing those parameters in the data stream of coded video data output by the system 1600. The controller 1660 also may select between different modes of operation by which the system may generate reference images and may include metadata identifying the modes selected for each portion of coded data.

During operation, the controller 1660 may revise operational parameters of the quantizer 1616 and the transform unit 1615 at different granularities of image data, either on a per pixel block basis or on a larger granularity (for example, per picture, per slice, per largest coding unit (“LCU”) or another region). In an embodiment, the quantization parameters may be revised on a per-pixel basis within a coded picture.

Additionally, as discussed, the controller 1660 may control operation of the in-loop filter 1630 and the prediction unit 1650. Such control may include, for the prediction unit 1650, mode selection (lambda, modes to be tested, search windows, distortion strategies, etc.), and, for the in-loop filter 1630, selection of filter parameters, reordering parameters, weighted prediction, etc.

And, further, the controller 1660 may perform transforms of reference pictures stored in the reference picture store when new packing configurations are defined for input video.

The principles of the present discussion may be used cooperatively with other coding operations that have been proposed for multi-view video. For example, the predictor 1650 may perform prediction searches using input pixel block data and reference pixel block data in a spherical projection. Operation of such prediction techniques are may be performed as described in U.S. patent application Ser. No. 15/390,202, filed Dec. 23, 2016 and U.S. patent application Ser. No. 15/443,342, filed Feb. 27, 2017, both of which are assigned to the assignee of the present application, the disclosures of which are incorporated herein by reference. In such an embodiment, the coder 1600 may include a spherical transform unit 1690 that transforms input pixel block data to a spherical domain prior to being input to the predictor 1650.

As indicated, the coded video data output by the video coder 230 (FIG. 2) should consume less bandwidth than the input data when transmitted and/or stored. The coding system 200 may output the coded video data to an output device 270, such as a transmitter, that may transmit the coded video data across a communication network 130 (FIG. 1). Alternatively, the coding system 200 may output coded data to a storage device (not shown) such as an electronic-, magnetic- and/or optical storage medium.

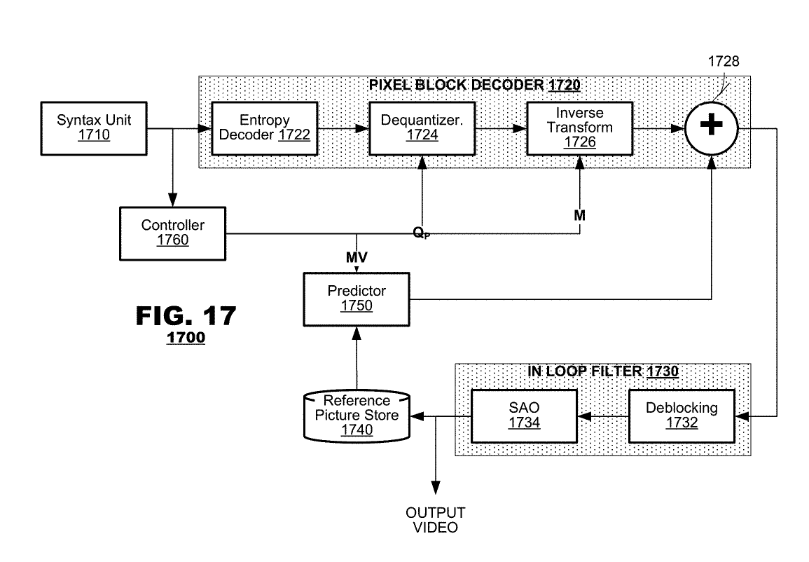

FIG. 17 is a functional block diagram of a decoding system 1700 according to an embodiment of the present disclosure. The decoding system 1700 may include a syntax unit 1710, a pixel block decoder 1720, an in-loop filter 1730, a reference picture store 1740, a predictor 1750, and a controller 1760. The syntax unit 1710 may receive a coded video data stream and may parse the coded data into its constituent parts. Data representing coding parameters may be furnished to the controller 1760 while data representing coded residuals (the data output by the pixel block coder 1610 of FIG. 16) may be furnished to the pixel block decoder 1720. The pixel block decoder 1720 may invert coding operations provided by the pixel block coder 1610 (FIG. 16). The in-loop filter 1730 may filter reconstructed pixel block data. The reconstructed pixel block data may be assembled into pictures for display and output from the decoding system 1700 as output video. The pictures also may be stored in the prediction buffer 1740 for use in prediction operations. The predictor 1750 may supply prediction data to the pixel block decoder 1720 as determined by coding data received in the coded video data stream.

The pixel block decoder 1720 may include an entropy decoder 1722, a dequantizer 1724, an inverse transform unit 1726, and an adder 1728. The entropy decoder 1722 may perform entropy decoding to invert processes performed by the entropy coder 1618 (FIG. 16). The dequantizer 1724 may invert operations of the quantizer 1716 of the pixel block coder 1610 (FIG. 16). Similarly, the inverse transform unit 1726 may invert operations of the transform unit 1614 (FIG. 16). They may use the quantization parameters Q_{P} and transform modes M that are provided in the coded video data stream. Because quantization is likely to truncate data, the data recovered by the dequantizer 1724, likely will possess coding errors when compared to the input data presented to its counterpart quantizer 1716 in the pixel block coder 1610 (FIG. 16).

The adder 1728 may invert operations performed by the subtractor 1610 (FIG. 16). It may receive a prediction pixel block from the predictor 1750 as determined by prediction references in the coded video data stream. The adder 1728 may add the prediction pixel block to reconstructed residual values output by the inverse transform unit 1726 and may output reconstructed pixel block data.

The in-loop filter 1730 may perform various filtering operations on reconstructed pixel block data. As illustrated, the in-loop filter 1730 may include a deblocking filter 1732 and an SAO filter 1734. The deblocking filter 1732 may filter data at seams between reconstructed pixel blocks to reduce discontinuities between the pixel blocks that arise due to coding. SAO filters 1734 may add offset to pixel values according to an SAO type, for example, based on edge direction/shape and/or pixel level. Other types of in-loop filters may also be used in a similar manner. Operation of the deblocking filter 1732 and the SAO filter 1734 ideally would mimic operation of their counterparts in the coding system 1600 (FIG. 16). Thus, in the absence of transmission errors or other abnormalities, the decoded picture obtained from the in-loop filter 1730 of the decoding system 1700 would be the same as the decoded picture obtained from the in-loop filter 1610 of the coding system 1600 (FIG. 16); in this manner, the coding system 1600 and the decoding system 1700 should store a common set of reference pictures in their respective reference picture stores 1640, 1740.

The reference picture store 1740 may store filtered pixel data for use in later prediction of other pixel blocks. The reference picture store 1740 may store decoded pixel block data of each picture as it is coded for use in intra prediction. The reference picture store 1740 also may store decoded reference pictures.

As discussed, the predictor 1750 may supply the transformed reference block data to the pixel block decoder 1720. The predictor 1750 may supply predicted pixel block data as determined by the prediction reference indicators supplied in the coded video data stream.

The controller 1760 may control overall operation of the decoding system 1700. The controller 1760 may set operational parameters for the pixel block decoder 1720 and the predictor 1750 based on parameters received in the coded video data stream. As is relevant to the present discussion, these operational parameters may include quantization parameters Q_{P} for the dequantizer 1724 and transform modes M for the inverse transform unit 1710. As discussed, the received parameters may be set at various granularities of image data, for example, on a per pixel block basis, a per picture basis, a per slice basis, a per LCU basis, or based on other types of regions defined for the input image.

And, further, the controller 1760 may perform transforms of reference pictures stored in the reference picture store 1740 when new packing configurations are detected in coded video data.

Embodiments of the present invention may mitigate boundary artifacts in coding systems 1600 and decoding systems 1700 by altering operation of in loop filters 1630, 1730 in those systems. According to such embodiments, in loop filters 1630, 1730 may be prevented from performing filtering on regions of decoded images that contain null data. For example, in FIG. 5, an cube map image 530 is illustrated having four null regions 537.1-537.4.

Embodiments of the present disclosure provide coding systems that generate padded images from input pictures and perform video coding/decoding operations on the basis of the padded images. Thus, a padded input image may be partitioned into a plurality of pixel blocks and coded on a pixel-block-by-pixel-block basis. An image pre-processor 220 (FIG. 2) may perform padding operations and extract pixel blocks from padded images to be coded by a video coder 230.

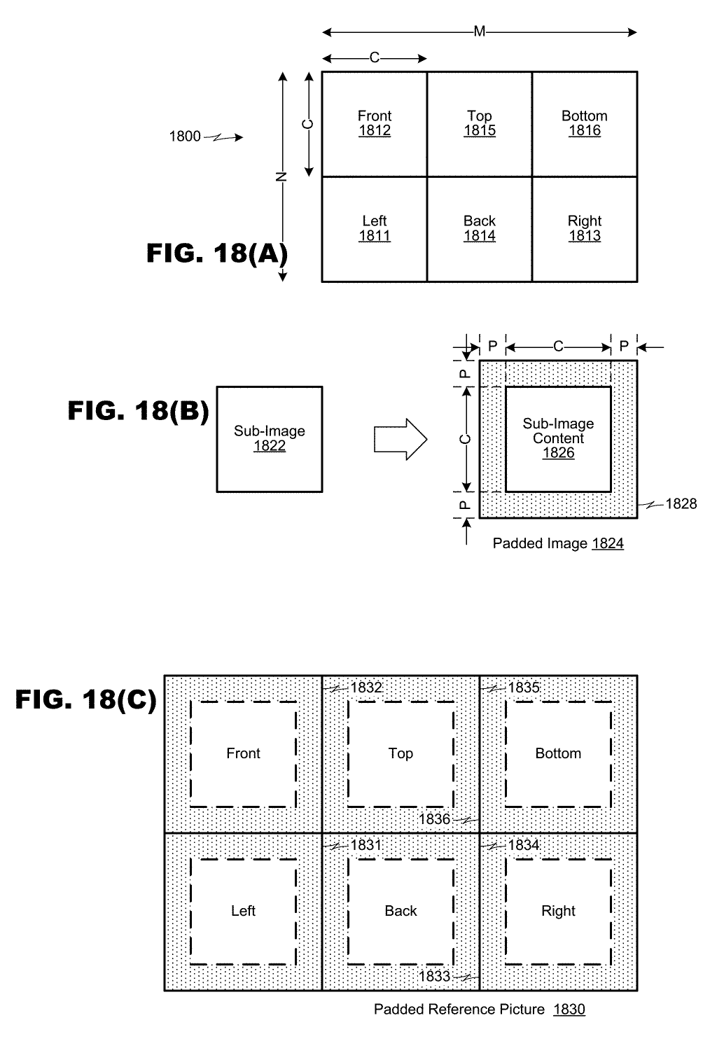

FIG. 18 illustrates operation of image padding according to an embodiment of the present disclosure. In this embodiment, an in loop filtering system may develop content padding around the different views of a multi-view image in order to perform prediction and/or filtering. FIG. 18(a) illustrates an exemplary multi-view image 1800 that may be obtained by the systems 1600, 1700 from decoding. The image 1800 may contain views 1812-1816. According to the embodiment, as shown in FIG. 18(b), each view 1822 may be extracted from the image 1800 and have padding content provided on edges of the view 1822. Thus, if a view from the image 1800 has a dimension of C×C pixels, a C+2p×C+2p image may be created for filtering purposes. The in loop filtering operations may be applied to the padded image 1824 and the filtered content of the CxC view 1826 may be returned to the image 1800. The padding and filtering operation may be repeated for each view 1812-1816 of the image 1800.

The padded image content may be derived from views that are adjacent to the view being filtered. For example, in the image space illustrated in FIG. 5, the front view 522 is bordered by the left view 521, the right view 523, the top view 525 and the bottom view 526. Image content from these views 521, 523, 525, and 526 that is adjacent to the front view 522 may be used as padding content in the filtering operations illustrated in FIG. 18. In an embodiment, the padding content may be generated by projecting image data from the adjacent views 521, 523, 525, and 526 to a spherical projection (FIG. 9) and projecting the image data from the spherical projection to the plane of the view 522 for which the padding data is being created (FIG. 10).

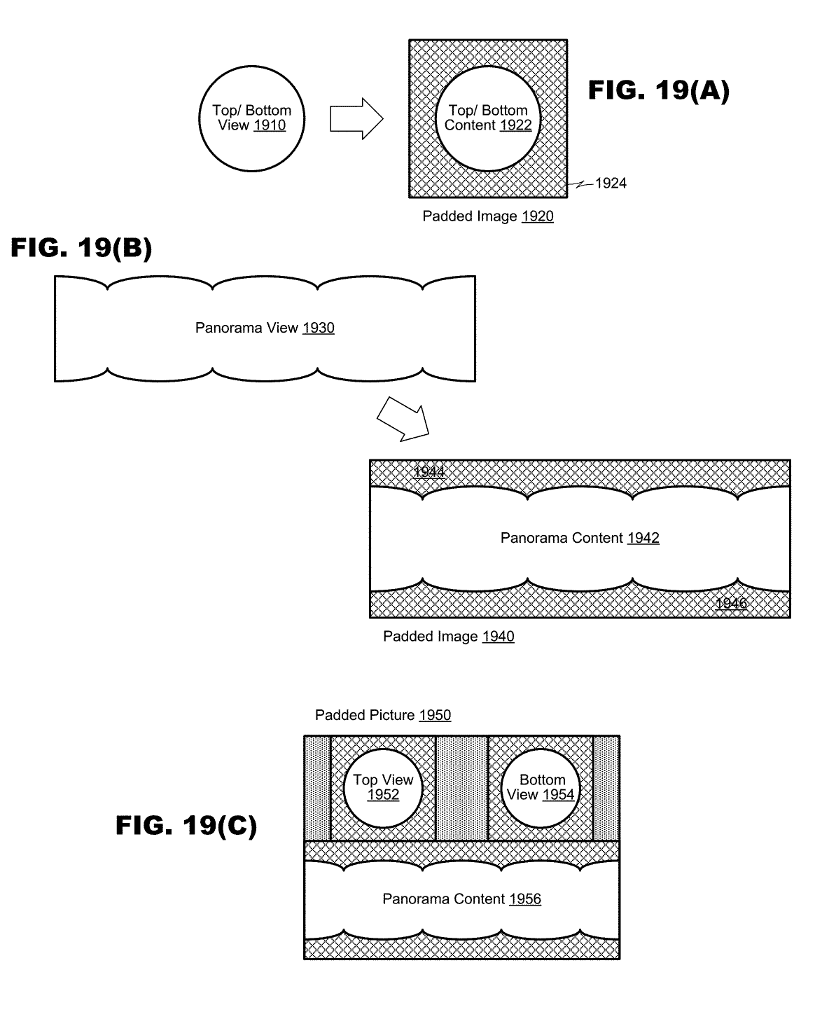

Similarly, for the image format 1900 illustrated in FIG. 19, a portion of the panoramic view 1920 border the top view 1912 and a different portion of the panoramic view 1920 borders the bottom view 1914. These portions may be used to develop padding content for the top view 1912 and the bottom view 1914. Similarly, edge portions of the top and bottom views 1912, 1914 may be used to develop padding content for filtering the panorama view 1920. In either case, a transform may be performed between the flat image space of the top and bottom views 1912, 1914 and the curved image space of the panorama view 1920 to align padded content to the image being filtered.

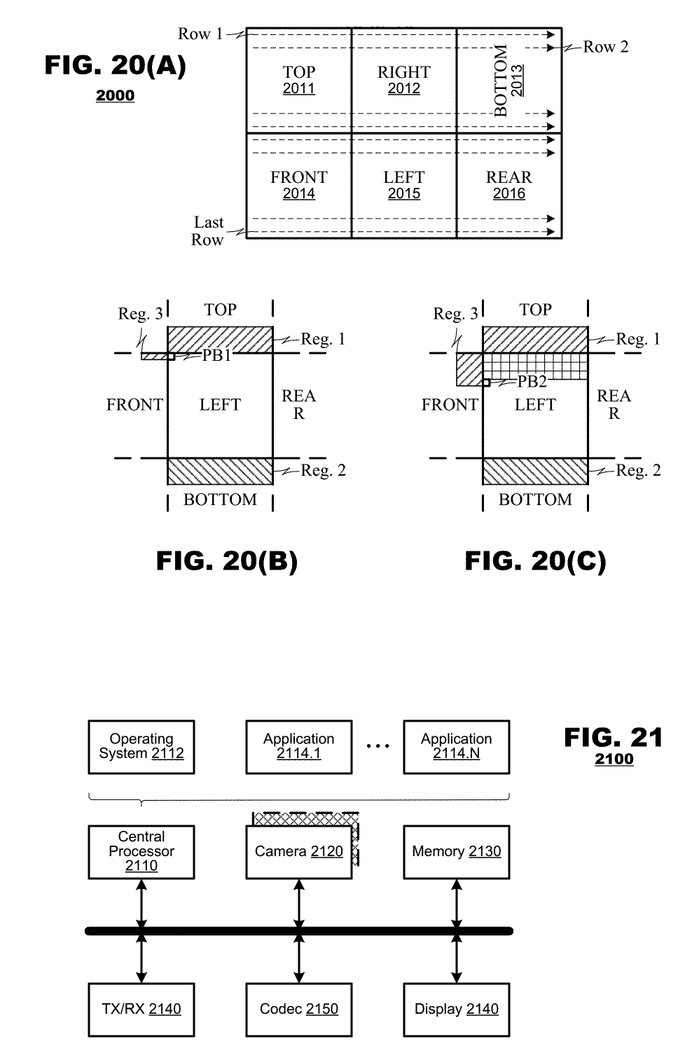

In another embodiment, shown in FIG. 20, source image padding may be performed by an encoder in loop while pixel blocks are being coded. FIG. 20(a) illustrates an exemplary cube map image 2000 that includes a top view 2011, a right view 2012, a bottom view 2013, a front view 2014, a left view 2015 and a rear view 2016. A video coding operation may parse a source image into pixel blocks and code the pixel blocks row by row in a raster scan pattern (rows 1, 2, etc.).

FIGS. 20(b) and 20(c) illustrate padding that may occur when coding a view such as the left view 2015 of FIG. 20(a). As shown in FIG. 20(b), when coding reaches a point of pixel block PB1, data of the top view 2011, and the bottom view 2013 will have been coded. Also, a portion of the front view 2014 will have been coded. Thus, padding data is available from a region (Reg. 1) of the tope view 2011 that borders the left 2015, from a region (Reg. 2) of the bottom view 2013, and from a portion of the front view 2014, shown as region Reg. 3. Once padded, pixel blocks may be retrieved from the padded source image for coding.

As coding progresses through other rows of the source image 2000 (FIG. 20(a)), additional portions of the front image will be available. For example, as shown in FIG. 20(c), when coding reaches a point of pixel block PB2, the region Reg. 3 of the front view 2014 will have expanded to include previously-coded rows. Thus, padding data is available from region Reg. 1 of the top view 2011, from region Reg. 2 of the bottom view 2013, and from the expanded region Reg. 3 from the front view 2014. Once padded, pixel blocks may be retrieved from the padded source image for coding.

In such embodiments, a coding syntax may be developed to notify decoding systems 1700 of the deblocking mode decisions performed by coding systems 1600. In one embodiment, it may be sufficient to provide a deblocking mode flag in coding syntax as follows:

| deblocking_mode | Operation |
|---|---|
| 0 | Original |
| 1 | Skip deblocking |
| 2 | Perform padding |

The foregoing embodiments may be performed without requiring padding data to be transmitted in a channel. Padding data may be derived from decoded video data contained in other views. Thus, in the absence of transmission errors between the coding system 1600 and the decoding system 1700, the coding system 1600 and the decoding system 1700 may develop padding data and perform filtering in parallel based on information that is available locally to each system.

In another embodiment, padded image data may be used in prediction operations for video coding. A predictor may interpolate reference pictures for prediction that include padding content provided adjacent to each view of a multi-view image. An exemplary padded reference picture 1830 is illustrated in FIG. 18(c), provided for a multi-view image 1800. In this example, image content of each view is provided with padded image data in an amount corresponding to a prediction search limit. Thus, when predicting image content of a front view 1812 of an input image, a predictor may have access to content 1832 representing front view content of a reference frame and padded content provided adjacent thereto. Similarly, when predicting image content of a left view 1811 of the input image, the predictor may have access to content 1831 representing left view content of a reference frame and padded content provided adjacent thereto. Each other view 1813-1816 of the input image may map similarly to corresponding padded content 1833-1836 of a reference picture. This principle finds application with the other image formats of FIGS. 4-6 and 11-15.

Embodiments of the present disclosure may create padded images 1830, 1930 (FIG. 18(c), FIG. 19(c)) from input images prior to coding by a video coder 230 (FIG. 2). The padded input pictures 1830, 1930 may be processed by the video coder 230 to code the input picture and, after transmission to another device, it may be processed by a video decoder 320 to recover the padded input pictures 1830, 1930.

In such an embodiment, video coders 230 (FIG. 2) and video decoders 320 (FIG. 3) may process pixel blocks from padded input pictures on a pixel block by pixel block basis, as described in connection with FIGS. 16 and 17. Thus, a coding system 1600 (FIG. 16) may process padded pixel blocks as a predictor 1650 performs inter-mode and intra-mode prediction searches 1652, 1654, using decoded frame data stored in a reference picture store 1640 for previously coded frames (inter-mode) and a current frame (inter-mode) as bases for prediction searches. As described, the decoded frame data may be obtained by decoding data of previously coded pixel blocks. Thus, the decoded frame data stored in the reference picture store 1640 also may possess a padded format. And, as discussed, the in loop filters 1630 also may process data in the padded format, as described to fix block artifacts in decoded data.

Similarly, a decoding system 1700 (FIG. 17) may process coded pixel blocks having padding information as it decodes coded video data. Decoded frame data stored in the reference picture store 1740 may possess a padded format. Thus, when the predictor 1750 retrieves prediction data from the reference picture store 1740 pursuant to coding parameters provided in channel data, it may furnish pixel block data having padded content to the pixel block decoder 1720. The in loop filters 1730 also may process data in the padded format, as described to fix block artifacts in decoded data.

The padding operations may be performed locally by an encoder and decoder without requiring signaling in a coded data stream representing content of the padded image data. In such embodiments, a coding syntax may be developed to notify decoding systems 1700 of the deblocking mode decisions performed by coding systems 1600. In one embodiment, it may be sufficient to provide a prediction_mode flag in coding syntax as follows:

| prediction_mode | Operation |
|---|---|
| 0 | No padding |
| 1 | Perform padding |

Such a flag permits an encoder and decoder to control whether to perform padding or not when developing reference pictures for prediction.

The foregoing discussion has described operation of the embodiments of the present disclosure in the context of video coders and decoders. Commonly, these components are provided as electronic devices. Video decoders and/or controllers can be embodied in integrated circuits, such as application specific integrated circuits, field programmable gate arrays and/or digital signal processors. Alternatively, they can be embodied in computer programs that execute on camera devices, personal computers, notebook computers, tablet computers, smartphones or computer servers. Such computer programs typically are stored in physical storage media such as electronic-, magnetic- and/or optically-based storage devices, where they are read to a processor and executed. Decoders commonly are packaged in consumer electronics devices, such as smartphones, tablet computers, gaming systems, DVD players, portable media players and the like; and they also can be packaged in consumer software applications such as video games, media players, media editors, and the like. And, of course, these components may be provided as hybrid systems that distribute functionality across dedicated hardware components and programmed general-purpose processors, as desired.

For example, the techniques described herein may be performed by a central processor of a computer system. FIG. 21 illustrates an exemplary computer system 2100 that may perform such techniques. The computer system 2100 may include a central processor 2110, one or more cameras 2120, a memory 2130, and a transceiver 2140 provided in communication with one another. The camera 2120 may perform image capture and may store captured image data in the memory 2130. The device also may include sink components, such as a codec 2150 and a display 2140, as desired.

The central processor 2110 may read and execute various program instructions stored in the memory 2130 that define an operating system 2112 of the system 2100 and various applications 2114.1-2114.N. As it executes those program instructions, the central processor 2110 may read, from the memory 2130, decoded image data created either by a codec 2150 or an application 2114.1 and may perform filtering controls as described hereinabove.

As indicated, the memory 2130 may store program instructions that, when executed, cause the processor to perform the techniques described hereinabove. The memory 2130 may store the program instructions on electrical-, magnetic- and/or optically-based storage media.

The transceiver 2140 may represent a communication system to receive coded video data from a network (not shown). In an embodiment where the central processor 2110 operates a software-based video codec, the transceiver 2140 may place coded video data in memory 2130 for retrieval by the processor 2110. In an embodiment where the system 2100 has a dedicated codec, the transceiver 2140 may provide coded video data to the codec 2150.

The foregoing discussion has described the principles of the present disclosure in terms of encoding systems and decoding systems. As described, an encoding system typically codes video data for delivery to a decoding system where the video data is decoded and consumed. As such, the encoding system and decoding system support coding, delivery and decoding of video data in a single direction. In applications where bidirectional exchange is desired, a pair of terminals 110, 120 (FIG. 1) each may possess both an encoding system and a decoding system. An encoding system at a first terminal 110 may support coding of video data in a first direction, where the coded video data is delivered to a decoding system at the second terminal 120. Moreover, an encoding system also may reside at the second terminal 120, which may code of video data in a second direction, where the coded video data is delivered to a decoding system at the second terminal 110. The principles of the present disclosure may find application in a single direction of a bidirectional video exchange or both directions as may be desired by system operators. In the case where these principles are applied in both directions, then the operations described herein may be performed independently for each directional exchange of video.

Several embodiments of the present disclosure are specifically illustrated and described herein. However, it will be appreciated that modifications and variations of the present disclosure are covered by the above teachings and within the purview of the appended claims without departing from the spirit and intended scope of the invention.

We claim:

1. An image correction method, comprising:
projecting image content of planar views from a multi-view image to a spherical projection,
projecting at least a portion of the image content from the spherical projection to a planar projection, and
displaying the image content projected on the planar projection.

2. The method of claim 1, wherein the portion of the image content is a view window selected from the spherical projection.

3. An image coding method, comprising:
for a multi-view image, projecting image content of a plurality of views of the image to a common spherical projection,
deriving a two dimensional image from the content of the spherical projection, wherein the two dimensional image has regions for each view of the multi-view image surrounded by padding content;
coding the two dimensional image by motion-compensation prediction.

4. The method of claim 3, wherein the coding comprises, for intra-coding, coding a pixel block that contains padded image content using decoded data of another pixel block from the same image as a basis of prediction.

5. The method of claim 3, wherein the coding comprises, for inter-coding, coding a pixel block that contains padded image content using decoded data of a pixel block from a previously-coded image as a basis of prediction.

6. The method of claim 3, further comprising decoding the coded two dimensional image, the decoding including deblocking filtering of recovered padded image content.

7. The method of claim 3, wherein, for one view of the multi-view image, padding content is derived from image data of another view of the multi-view image.

8. The method of claim 1, wherein the multi-view image contains a plurality of planar views of image data.

9. The method of claim 1, wherein the multi-view image contains a plurality of planar views of image data and a panoramic view of image data.

10. A system, comprising:
a pre-processor having an input for a multi-view image to:
project image content of a plurality of views of the multi-view image to a common spherical projection, and
derive a two dimensional image from the content of the spherical projection, wherein the two dimensional image has regions for each view of the multi-view image surrounded by padding content;
a motion compensation prediction video coder having an input for image data output by the pre-processor.

11. The system of claim 10, wherein the video coder comprises:
a pixel block coder having an input for a pixel block from the pre-processor image data and an input for prediction data and an output for coded pixel block data,
a pixel block decoder having an input for the coded pixel block data,
a reference picture store for storing a decoded images obtained from the pixel block decoder, the decoded images containing padding content, and
a predictor, having an input for reference picture data from the reference picture store and an output for the prediction data.

12. The system of claim 11, wherein, for intra-coding of a pixel block, the predictor outputs decoded data of another pixel block from the same image as the pixel block as the prediction data.

13. The system of claim 11, wherein, for intra-coding of a pixel block, the predictor outputs decoded data of a pixel block from a different image as the pixel block as the prediction data.

14. The system of claim 11, further comprising a deblocking filter provided in a communication path between the pixel block decoder and the reference picture store to deblock filter decoded images including the padded image content.

15. A computer readable medium storing program instructions that, when executed by a processing device, cause the device to perform a method, comprising:
for a multi-view image, projecting image content of a plurality of views of the image to a common spherical projection,
deriving a two dimensional image from the content of the spherical projection, wherein the two dimensional image has regions for each view of the multi-view image surrounded by padding content;
coding the two dimensional image by motion-compensation prediction.

16. An image decoding method, comprising:
decoding a coded two dimensional image by motion-compensation, the two dimensional image representing content of multiple views about a common reference point, the two dimensional image having regions for each view of the multi-view image surrounded by padding content;
storing a decoded two dimensional image in a reference picture store for use in decoding of a later-received coded two dimensional image having padding content.

17. The method of claim 16, wherein the decoding comprises, for an intra-coded pixel block of the coded two dimensional image that contains padded image content, decoding the pixel block using decoded data of another pixel block from the same image as a basis of prediction.

18. The method of claim 16, wherein the decoding comprises, for an intra-coded pixel block of the coded two dimensional image that contains padded image content, decoding the pixel block using decoded data of a pixel block from a previously-coded image as a basis of prediction.

19. The method of claim 16, wherein the decoding comprises deblocking filtering the decoded two dimensional image including the padded image content.

20. The method of claim 16, wherein, for one view of the multi-view image, the padding content is derived from image data of another view of the retrieved multi-view image.

21. The method of claim 16, wherein the coded multi-view image and the retrieved multi-view image each contains a plurality of planar views of image data.

22. The method of claim 16, wherein the coded multi-view image and the retrieved multi-view image each contains a plurality of planar views of image data and a panoramic view of image data.

23. A system, comprising:
a motion compensation prediction video decoder having an input for coded image data representing content of multiple views about a common reference point, the two dimensional image having regions for each view of the multi-view image surrounded by padding content;
a post-processor having an input for a decoded multi-view image to derive an image from the decoded multi-view image content without padding content.

24. The system of claim 23, wherein the decoder comprises:
a pixel block decoder having an input for a coded pixel block data from the coded image data and an input for prediction data,
a reference picture store for storing a decoded images obtained from the pixel block decoder, the decoded images containing padding content, and
a predictor, having an input for reference picture data from the reference picture store and an output for the prediction data.

25. The system of claim 24, wherein, for an intra-coded pixel block, the predictor outputs decoded data of another pixel block from the same image as the coded pixel block as the prediction data.

26. The system of claim 24, wherein, for an intra-coded pixel block, the predictor outputs decoded data of a pixel block from the a different image as the coded pixel block as the prediction data.

27. The system of claim 24, further comprising a deblocking filter provided in a communication path between the pixel block decoder and the reference picture store to deblock filter decoded images including the padded image content.

28. A computer readable medium storing program instructions that, when executed by a processing device, cause the device to perform a method, comprising:
decoding a coded two dimensional image by motion-compensation, the two dimensional image representing content of multiple views about a common reference point, the two dimensional image having regions for each view of the multi-view image surrounded by padding content;
storing a decoded two dimensional image in a reference picture store for use in decoding of a later-received coded two dimensional image having padding content.
